(19) United States
(12) Patent Application Publication
(10) Pub. No.: US 2026/0292346 A1
(43) Pub. Date: Sep. 24, 2026

(54) SYSTEM AND CONTROL METHOD

(71) Applicant: CANON KABUSHIKI KAISHA, Tokyo (JP)

(72) Inventor: FUMIHIKO KATO, Kanagawa (JP)

(21) Appl. No.: 19/574,102

(22) Filed: Mar. 20, 2026

(30) Foreign Application Priority Data
Mar. 24, 2025 (JP) 2025-049083

(51) Int. Cl. H04N 23/695; H04N 23/61; H04N 23/69

(52) U.S. Cl. CPC H04N 23/695; H04N 23/61; H04N 23/69

(57) ABSTRACT

A system detects a plurality of objects included in an image, sets a plurality of tracking target objects including a representative target object from the detected plurality of objects, tracks the plurality of tracking target objects by controlling an angle of view so that the representative target object falls within a predetermined position and/or size.

### BACKGROUND

### Field of the Technology

The aspect of the embodiments relates to a system that tracks a plurality of objects included in a captured image.

### Description of the Related Art

There is provided a technique of tracking a specific object by an image capture apparatus for which pan/tilt/zoom (PTZ) can be remotely controlled. In such automatic tracking control, the PTZ operation of the image capture apparatus is controlled so that a tracking target object falls within the angle of view.

Japanese Patent Laid-Open No. 2019-29886 describes a technique of detecting a plurality of objects from a captured image and automatically tracking the plurality of detected objects as tracking targets.

When automatically tracking a plurality of objects, a PTZ operation is controlled so that a plurality of tracking target objects including a representative target object designated from the plurality of objects fall within the angle of view. However, when the position of the representative target object changes, the size of the representative target object changes, or the representative target object is lost, it may become difficult to control the angle of view so that the representative target object falls within a predetermined position or size.

### SUMMARY

The aspect of the embodiments is directed to a system which tracks a plurality of objects included in an image, comprising: at least one processor; and at least one memory which stores a program which, when executed by the at least one processor, causes the at least one processor to function as: a detection unit that detects a plurality of objects from the image; a setting unit that sets a plurality of tracking target objects including a representative target object from the detected plurality of objects; and a control unit that tracks the plurality of tracking target objects by controlling an angle of view so that the representative target object falls within a predetermined position and/or size.

Features of the disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure, and together with the description, serve to explain the principles of the embodiments.

FIG. 1 is a view showing a system configuration according to an embodiment;

FIG. 2 is a block diagram exemplifying the hardware configurations of an image capture apparatus and a control apparatus according to the embodiment;

FIGS. 3A and 3B are block diagrams respectively exemplifying the functional configurations of the image capture apparatus and the control apparatus according to the embodiment;

FIGS. 4A to 4D are views exemplifying a captured image and objects included in the captured image according to the embodiment;

FIG. 5 is a sequence chart exemplifying the operation of a system according to the embodiment;

FIGS. 6A and 6B are flowcharts exemplifying control processing of the system according to the first embodiment;

FIGS. 7A to 7D are views illustrating processing of excluding a tracking target object in the control processing of the system according to the first embodiment;

FIG. 8 is a view exemplifying a GUI for setting the position and/or size of a representative target object, tracking target objects, and an object to be excluded in the control processing of the system according to the first embodiment;

FIGS. 9A and 9B are flowcharts exemplifying the control processing of the system after tracking processing according to the first embodiment;

FIGS. 10A to 10D are views illustrating processing performed when the representative target object does not fall within a predetermined position and/or size in the control processing of the system after the tracking processing according to the first embodiment;

FIGS. 11A and 11B are flowcharts exemplifying control processing of a system after tracking processing according to the second embodiment;

FIGS. 12A to 12F are views illustrating processing performed when a representative target object does not fall within a predetermined position and/or size in the control processing of the system after the tracking processing according to the second embodiment;

FIGS. 13A and 13B are flowcharts exemplifying control processing of a system after tracking processing according to the third embodiment; and

FIGS. 14A to 14F are views illustrating tracking inhibited region setting processing and tracking processing in the control processing of the system after the tracking processing according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

The first embodiment will be described below.

### System Configuration

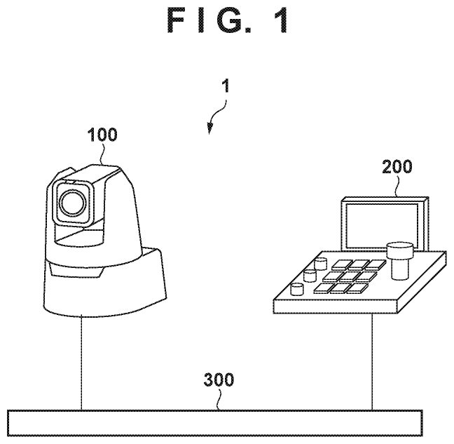

A system configuration according to this embodiment will be described first with reference to FIG. 1.

FIG. 1 exemplifies the system configuration according to this embodiment.

An image capture system 1 according to this embodiment includes an image capture apparatus 100 and a control apparatus 200. The image capture apparatus 100 and the control apparatus 200 are communicably connected via a network 300. Note that the number of image capture apparatuses 100 is not limited to one and may be plural (two or more).

The image capture system 1 according to this embodiment causes the image capture apparatus 100 to capture an image, detects a plurality of objects from the captured image, and causes the control apparatus 200 to select a plurality of tracking target objects including a representative target object from the plurality of objects, and then the image capture apparatus 100 performs processing of tracking the plurality of tracking target objects selected by the control apparatus 200.

The tracking target object is an object determined in advance as the target of the tracking processing by the image capture apparatus 100. An example of the tracking target object is a person. In this embodiment, while setting a plurality of objects as tracking target objects, it is possible to capture an image at such an angle of view that the representative target object among the plurality of tracking target objects falls within a predetermined position and/or size. In this case, the PTZ operation of the image capture apparatus 100 is controlled so that the plurality of tracking target objects fall within the angle of view of the image capture apparatus 100. However, if control is simply executed so that the plurality of tracking target objects fall within the angle of view of the image capture apparatus 100, the size of the representative target object may become excessively small when zooming out in response to the plurality of tracking target objects spreading within the angle of view, and it may be impossible to capture an image at such an angle of view that the representative target object falls within the predetermined size. To avoid the size of the representative target object from becoming excessively small, it is considered to stop zooming at a given size. However, in this case, when the representative target object moves away from other tracking target objects, the representative target object may be framed out and it may be impossible to capture an image at such an angle of view that the representative target object falls within the predetermined position. To cope with this, in this embodiment, a tracking target object (unnecessary target object) to be excluded in order to control the angle of view so that the position and/or size of the representative target object falls within the predetermined position and/or size is extracted and excluded from the tracking target objects. Thus, it is possible to execute tracking at such an angle of view that the representative target object falls within the predetermined position and/or size while keeping the plurality of tracking target objects within the angle of view.

The image capture apparatus 100 according to this embodiment is a digital camera that can capture a still image and a moving image. Alternatively, the image capture apparatus 100 may be an information processing apparatus such as a personal computer, a smartphone, or a tablet computer. The image capture apparatus 100 has a PTZ function. The PTZ function is a function capable of controlling pan, tilt, and zoom of the image capture apparatus 100. PTZ is an acronym for Pan, Tilt, and Zoom. Pan is movement of the optical axis of the image capture apparatus 100 in the horizontal direction. Tilt is movement of the optical axis of the image capture apparatus 100 in the vertical direction. Zoom indicates zoom-in (telephoto) and zoom-out (wide angle). Pan and tilt are functions of changing the image capture direction of the image capture apparatus 100. Zoom is a function of changing the image capture range (angle of view) of the image capture apparatus 100. In this embodiment, an image captured by the image capture apparatus 100 will be referred to as a captured image hereinafter.

The control apparatus 200 is an information processing apparatus such as a dedicated computer, a remote controller, a personal computer, a smartphone, or a tablet computer. The control apparatus 200 functions as a controller that controls the image capture apparatus 100. The control apparatus 200 according to this embodiment obtains a captured image and a detection result of objects included in the captured image from the image capture apparatus 100, and displays the obtained information, thereby accepting a user operation of selecting a tracking target object from the plurality of objects. Furthermore, the control apparatus 200 sets the selected object as the tracking target object, and transmits information indicating the set tracking target object to the image capture apparatus 100.

The image capture apparatus 100 and the control apparatus 200 may be formed by a single computer or implemented by distributed processing by a plurality of computers.

The network 300 is implemented by the Internet, a Local Area Network (LAN), or a Wide Area Network (WAN). The network 300 is not limited to the Internet, and may be implemented by one or a combination of a telephone line, a dedicated digital line, an Asynchronous Transfer Mode (ATM), a frame relay line, a cable television line, a data broadcast radio line, and the like.

### Apparatus Configuration

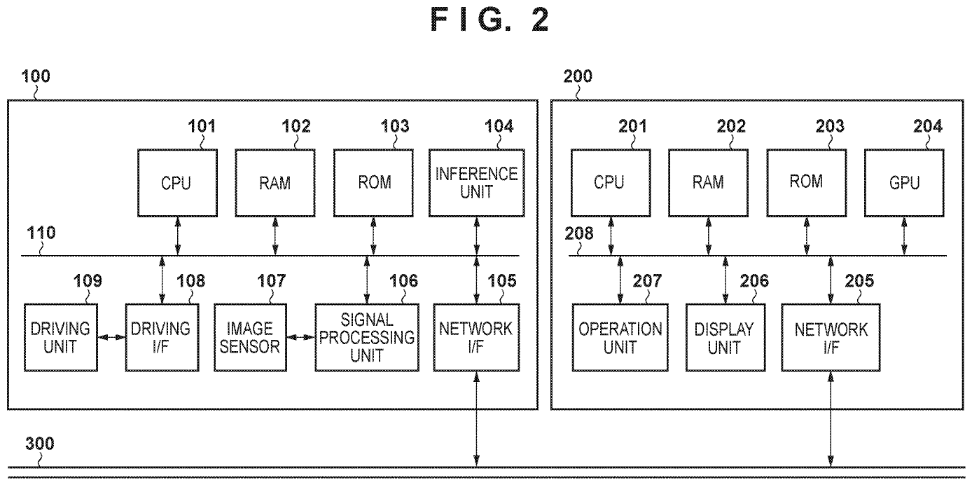

The configurations and functions of the image capture apparatus 100 and the control apparatus 200 according to this embodiment will be described with reference to FIG. 2.

FIG. 2 is a block diagram exemplifying the hardware configurations of the image capture apparatus 100 and the control apparatus 200 according to this embodiment.

The image capture apparatus 100 includes a CPU 101, a RAM 102, a ROM 103, an inference unit 104, a network I/F 105, a signal processing unit 106, an image sensor 107, a driving I/F 108, and a driving unit 109, and these are connected to be able to transmit/receive data via a bus 110.

The CPU 101 is an arithmetic processing unit that controls the entire image capture apparatus 100. The CPU 101 controls the respective components of the image capture apparatus 100 by loading programs and data stored in the ROM 103 into the RAM 102 and executing the programs.

The RAM 102 is a volatile storage device such as a DRAM. The RAM 102 stores a program loaded from the ROM 103, a captured image, and various kinds of information such as a setting instruction and a control instruction obtained from the control apparatus 200. The RAM 102 includes a work area used by the CPU 101 and the inference unit 104 to execute various processes.

The ROM 103 is a nonvolatile storage device such as a hard disk drive (HDD), a solid-state drive (SSD), or a flash memory. The ROM 103 stores settings of the image capture apparatus 100, and programs and data associated with activation and a basic operation of the image capture apparatus 100. The ROM 103 stores data and programs to be executed as control processing of the image capture apparatus 100 of this embodiment by the CPU 101 and the inference unit 104.

The inference unit 104 receives a captured image as an input, and executes inference processing using machine learning such as deep learning by using a learned inference model and inference parameters, thereby performing inference processing of estimating the presence/absence of an object, the region of the object, and the like. The inference unit 104 is, for example, an arithmetic device such as a Graphics Processing Unit (GPU) specialized in image processing and inference processing. Note that an arithmetic device such as a Field Programmable Gate Array (FPGA) may be used instead of the inference unit 104. In addition, the processing of the inference unit 104 may be performed by the CPU 101 and the GPU or DSP in cooperation with each other or by one of the CPU 101 and the GPU or DSP.

The network I/F (interface) 105 transmits/receives various kinds of information to/from an external device connected to the network 300 by wireless communication or wired communication via a communication medium such as Wi-Fi® or Ethernet®.

The signal processing unit 106 converts an image signal output from the image sensor 107 into a captured image as data in a predetermined format, and compresses the converted captured image as needed, thereby outputting it to the RAM 102. Note that the signal processing unit 106 may perform, on the image signal output from the image sensor 107, various processes such as image quality adjustment including color correction, exposure correction, and sharpness correction, and crop processing of cropping an image into only a predetermined region. These processes by the signal processing unit 106 may be executed in accordance with an instruction received from the control apparatus 200 via the network I/F 105.

The image sensor 107 receives light reflected by an object, converts the brightness and color of the received light into charges, and outputs an image signal based on the conversion result. The image sensor 107 includes, for example, a photodiode, a Charge Coupled Device (CCD) sensor, or a Complementary Metal Oxide Semiconductor (CMOS) sensor.

The driving I/F 108 is an interface for transmitting/receiving information such as a control instruction to/from the driving unit 109. The driving unit 109 includes a driving mechanism such as an actuator or a motor for changing the image capture direction and image capture range of the image capture apparatus 100. The driving unit 109 performs a PTZ operation in accordance with a control instruction received from the CPU 101 via the driving I/F 108.

The control apparatus 200 includes a CPU 201, a RAM 202, a ROM 203, a GPU 204, a network I/F 205, a display unit 206, and an operation unit 207, and these are connected to be able to transmit/receive data via a bus 208.

The CPU 201 is an arithmetic processing unit that controls the entire control apparatus 200. The CPU 201 controls the respective components of the control apparatus 200 by loading programs and data stored in the ROM 203 into the RAM 202 and executing the programs.

The RAM 202 is a volatile storage device such as a DRAM. The RAM 202 stores a program loaded from the ROM 203, and various kinds of information such as a captured image, a detection result, and an operation state obtained from the image capture apparatus 100. The RAM 202 includes a work area used by the CPU 201 and the GPU 204 to execute various processes.

The ROM 203 is a nonvolatile storage device such as a hard disk drive (HDD), a solid-state drive (SSD), or a flash memory. The ROM 203 stores settings of the control apparatus 200, and programs and data associated with activation and a basic operation of the control apparatus 200. The ROM 203 stores data and programs to be executed as control processing of the control apparatus 200 of this embodiment by the CPU 201 and the GPU 204.

The GPU 204 receives a captured image as an input, and executes inference processing using machine learning such as deep learning by using a learned inference model and inference parameters, thereby performing inference processing of estimating the presence/absence of an object, the region of the object, and the like. The GPU 204 is, for example, an arithmetic device specialized in image processing and inference processing. Note that an arithmetic device such as a Field Programmable Gate Array (FPGA) may be used instead of the GPU 204. In addition, the processing of the GPU 204 may be performed by the CPU 201 and the GPU or DSP in cooperation with each other or by one of the CPU 201 and the GPU or DSP.

The network I/F (interface) 205 transmits/receives various kinds of information to/from an external device connected to the network 300 by wireless communication or wired communication via a communication medium such as Wi-Fi® or Ethernet® .

The display unit 206 includes, for example, a display device such as a liquid crystal display or an organic EL display and a touch panel integrated with the display device. The display unit 206 displays the captured image and the detection result obtained from the image capture apparatus 100, and displays a Graphical User Interface (GUI) such as the setting screen of the control apparatus 200. Note that the disclosure is not limited to the configuration in which the control apparatus 200 includes the display unit 206, and a display device may be connected as an external device to the control apparatus 200 and may display the captured image and the GUI.

The operation unit 207 is an interface for accepting a user operation on the control apparatus 200. The operation unit 207 includes, for example, an input device such as a switch, a button, a joystick, a touch panel, a mouse, and a keyboard.

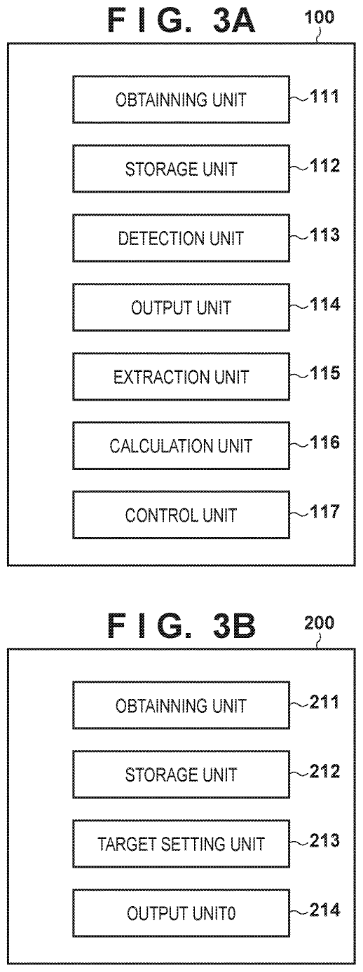

FIG. 3A is a block diagram exemplifying the functional configuration of the image capture apparatus 100.

The image capture apparatus 100 includes an obtaining unit 111, a storage unit 112, a detection unit 113, an output unit 114, an extraction unit 115, a calculation unit 116, and a control unit 117.

The obtaining unit 111 obtains information from the control apparatus 200. The information obtained by the obtaining unit 111 includes, for example, information indicating an object set as a tracking target object.

The storage unit 112 stores information obtained by the obtaining unit 111, and information such as a captured image generated by the image capture apparatus 100.

The detection unit 113 detects an object such as a person from the captured image, and detects the region of the object in the captured image. The region of the object in the captured image includes, for example, the size of the object in the captured image, the length of the object in the captured image, and the position of the object in the captured image. The detection unit 113 detects the object from the captured image by executing inference processing using machine learning such as deep learning by using a learned inference model and inference parameters, and outputs, as a detection result, information indicating coordinates corresponding to the region of the object. Note that the coordinates corresponding to the region of the object include, for example, coordinates corresponding to the region of a part or the whole of the object in the captured image. The coordinates corresponding to a part of the object include, for example, coordinates corresponding to the contour of the object and coordinates corresponding to the head or face of the object that is a person. The coordinates corresponding to a part of the object include, for example, in a case where the detection unit 113 detects the object as a rectangle, the coordinates of the upper left corner and lower right corner of the rectangle, the center coordinates of the rectangle, coordinates corresponding to the widthwise direction of the rectangle, and coordinates corresponding to the height direction of the rectangle. In this embodiment, the detection unit 113 serves as an object detection unit that detects a specific object from the captured image. The specific object includes a predetermined type of object that has been determined as a candidate for a tracking target object. The detection unit 113 also serves as a position detection unit that detects the position of the tracking target object in the captured image.

Note that an object detection method by the detection unit 113 is not limited to a machine learning method. The detection unit 113 may use a template matching method of comparing the captured image with a template image including a detection target object and detecting, as a region indicating the object, a region of the captured image, which has high similarity to the object included in the template image. As the object detection method by the detection unit 113, both machine learning and template matching may be used. In addition, the detection target object of the detection unit 113 may be an object different from a person.

Furthermore, the detection unit 113 identifies each detected object by detecting the feature of the detected object, and generates, for each identified object, information for identifying the object. The detection unit 113 executes inference processing using machine learning such as deep learning by using a learned inference model and inference parameters, thereby outputting, as a detection result, information indicating the feature amount of the object from the captured image and the region of the object in the captured image. The feature amount of the object extracted by the detection unit 113 may be the feature amount of the whole of the object or the feature amount of a part of the object such as the head or face of the person. The feature amount of the object includes, for example, the feature vector of the image. In this case, captured images generated by capturing each object at various angles may be used as learning images, and an inference model that receives the images with the same object which are labeled with the same ID and outputs the feature vector may be used. Note that the inference model used by the detection unit 113 to identify the object is not limited to a specific model, and any learning model may be used.

Note that the object identification method by the detection unit 113 is not limited to a method using machine learning such as deep learning. The detection unit 113 may predict, from transition of the region of the object in past sequential captured images, the region of the object in the latest captured image by a Kalman filter or the like, and identify the object closest to the predicted region as the same object. As the object identification method by the detection unit 113, both machine learning and the prediction identification method may be used.

If the detection unit 113 generates, by detection of the object, information indicating coordinates corresponding to the region of the object and information indicating the feature amount of the object, it stores the generated information in the storage unit 112. Note that the information indicating coordinates corresponding to the region of the object and the information indicating the feature amount of the object, which are generated by the detection unit 113, are included in the detection result, by the detection unit 113, of the object included in the captured image.

The output unit 114 outputs information to the control apparatus 200. The information output from the output unit 114 includes, for example, the captured image, and the information indicating the detection result, by the detection unit 113, of the object included in the captured image.

The extraction unit 115 extracts the tracking target object from the captured image. The extraction unit 115 extracts the tracking target object from the information received, from the control apparatus 200, as information indicating the object set as the tracking target object, and the detection result by the detection unit 113 for the captured image. In a case where the captured image includes a plurality of tracking target objects, the extraction unit 115 extracts all the tracking target objects included in the captured image. If the extraction unit 115 extracts the tracking target object, it stores, in the storage unit 112, information indicating which of the objects detected by the detection unit 113 is the tracking target object.

The calculation unit 116 sets, as a tracking target group, the plurality of tracking target objects extracted by the extraction unit 115, and calculates the reference position of the tracking target group in the captured image and the reference size of the tracking target group in the captured image. Calculation processing by the calculation unit 116 will be described later.

The control unit 117 controls a PTZ operation by the driving unit 109 (see FIG. 2) of the image capture apparatus 100. When performing zoom by the driving unit 109, the control unit 117 controls zoom by the driving unit 109 so that it is possible to continue tracking, using the image capture apparatus 100, the plurality of tracking target objects extracted by the extraction unit 115. If, by performing zoom by the driving unit 109, it becomes impossible to continue tracking, using the image capture apparatus 100, any of the plurality of tracking target objects extracted by the extraction unit 115, the control unit 117 limits zoom (for example, limits the range of the angle of view settable by zoom control).

Each of the functions of the obtaining unit 111, the detection unit 113, the output unit 114, the extraction unit 115, the calculation unit 116, and the control unit 117 of the image capture apparatus 100 is implemented by the hardware shown in FIG. 2 and/or a software program executed by the CPU 101 or the inference unit 104. The storage unit 112 of the image capture apparatus 100 is implemented by the RAM 102 or the ROM 103.

FIG. 3B is a block diagram showing the functional configuration of the control apparatus 200.

The control apparatus 200 includes an obtaining unit 211, a storage unit 212, a target setting unit 213, and an output unit 214.

The obtaining unit 211 obtains information from the image capture apparatus 100. The information obtained by the obtaining unit 211 includes, for example, the captured image and information indicating the detection result for the captured image by the detection unit 113 of the image capture apparatus 100.

The storage unit 212 stores information obtained by the obtaining unit 211 and information generated by the control apparatus 200.

The target setting unit 213 sets a tracking target object. The target setting unit 213 displays, on the display unit 206 (see FIG. 2), the captured image transmitted from the image capture apparatus 100, information indicating objects detected by the detection unit 113 from the captured image, and the like. In addition, the target setting unit 213 accepts a tracking target object selection instruction corresponding to a user operation on the information displayed on the display unit 206, sets, as a tracking target object, the object selected by the user, generates information indicating which of the objects is set as the tracking target object, and stores the generated information in the storage unit 212. The target setting unit 213 accepts the setting of the position and/or size of a representative target object corresponding to a user operation on the information displayed on the display unit 206 and the setting of an unnecessary target object, and stores the settings in the storage unit 212.

The output unit 214 outputs information to the image capture apparatus 100 or the control apparatus 200. The information output from the output unit 214 to the image capture apparatus 100 includes, for example, information generated by the target setting unit 213 as information indicating which of the objects is set as the tracking target object, information indicating the setting of the position and/or size of the representative target object, and information indicating the setting of the unnecessary target object. The information output from the output unit 214 to the control apparatus 200 includes, for example, an image displayed on the display unit 206.

Each of the functions of the obtaining unit 211, the target setting unit 213, and the output unit 214 of the control apparatus 200 is implemented by the hardware shown in FIG. 2 and/or a software program executed by the CPU 201 or the GPU 204. The storage unit 212 of the control apparatus 200 is implemented by the RAM 202 or the ROM 203.

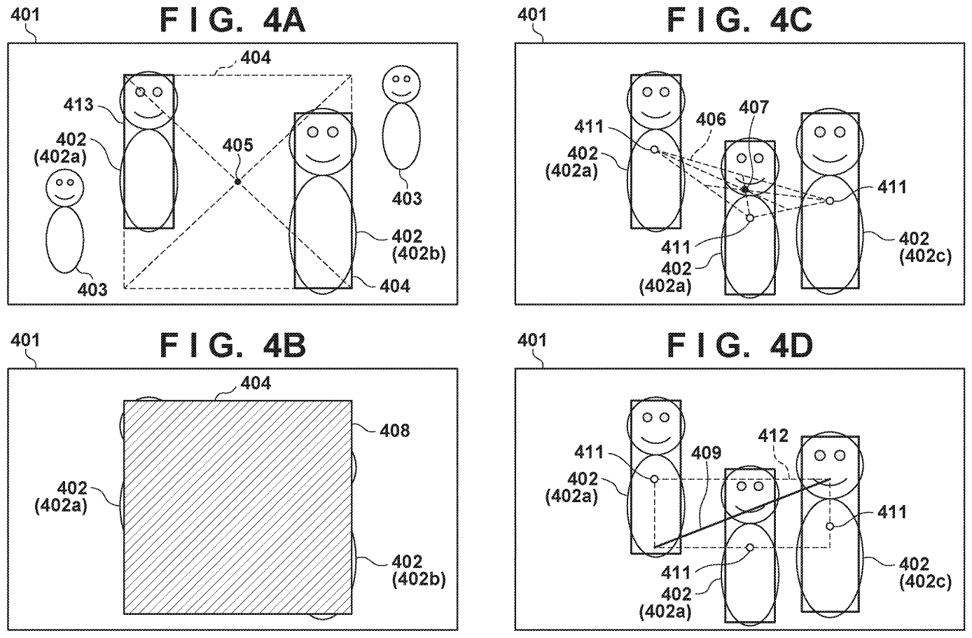

FIGS. 4A to 4D are views exemplifying the captured image and objects included in the captured image.

FIG. 4A exemplifies a captured image 401 that includes a plurality of tracking target objects 402 including a tracking target object 402a and a tracking target object 402b, and a plurality of non-tracking target objects 403 none of which is a tracking target object. In this embodiment, the plurality of tracking target objects 402 including the tracking target object 402a and the tracking target object 402b correspond to a tracking target group.

In the captured image 401 shown in FIG. 4A, a rectangular image 413 is shown in each of a region superimposed on the tracking target object 402a and a region superimposed on the tracking target object 402b. The rectangular image 413 is a rectangular image indicating the region of the tracking target object 402 detected by the detection unit 113.

The calculation unit 116 calculates the reference position of the tracking target group from the captured image 401 shown in FIG. 4A. More specifically, the calculation unit 116 calculates a rectangular region 404 as a rectangular region including the rectangular image 413 for each tracking target object 402, and calculates the center region of the calculated rectangular region 404 as a reference position 405 of the tracking target group. Furthermore, as shown in FIG. 4B, the calculation unit 116 calculates, as the size of the tracking target group, a rectangular area 408 that is the area of the calculated rectangular region 404.

Note that the reference position and/or size of the tracking target group calculated by the calculation unit 116 is not limited to the above-described example.

In the captured image 401 shown in FIG. 4C, a tracking target group corresponding to the plurality of tracking target objects 402 including the tracking target object 402a, the tracking target object 402b, and a tracking target object 402c is shown. FIG. 4C shows the rectangular image 413 for each tracking target object 402. In this case, the calculation unit 116 may calculate, for each rectangular image 413, a central region 411 that is the central region of the region surrounded by the rectangular image 413, and calculate, as a reference position 407 of the tracking target group, coordinates that are the average values of coordinates corresponding to the calculated central regions 411. In this case, the coordinates that are the average values of the coordinates corresponding to the central regions 411 may be calculated from the weighted averages of the coordinates corresponding to the central regions 411. Thus, the reference position of the tracking target group is close to a region where more tracking target objects of the tracking target group gather. Therefore, in a case where the driving unit 109 of the image capture apparatus 100 performs a PTZ operation by setting the reference position of the tracking target group as a target position, it is possible to perform an operation targeting a region where more tracking target objects of the tracking target group gather.

Note that as shown in FIG. 4C, if the number of tracking target objects 402 forming the tracking target group is three or more, coordinates corresponding to the region of the centroid of a polygon 406 having each central region 411 as a vertex match the coordinates that are the average values of the coordinates corresponding to the central regions 411. Therefore, the coordinates corresponding to the region of the centroid of the polygon 406 may be calculated as the reference position 407 of the tracking target group.

In a case where each central region 411 is calculated, the calculation unit 116 calculates a rectangular region 412 including the central regions 411, as shown in FIG. 4D. Then, the calculation unit 116 may calculate, as the size of the tracking target group, a higher one of a ratio of the width of the rectangular region 412 to the width of the captured image 401 and a ratio of the height of the rectangular region 412 to the height of the captured image 401. The width of the captured image 401 or the rectangular region 412 means the length in the horizontal direction in FIG. 4D. The height of the captured image 401 or the rectangular region 412 means the length in the vertical direction in FIG. 4D. In the example shown in FIG. 4D, the ratio of the width of the rectangular region 412 to the width of the captured image 401 is higher than the ratio of the height of the rectangular region 412 to the height of the captured image 401. Therefore, the ratio of the width of the rectangular region 412 to the width of the captured image 401 is obtained as the size of the tracking target group. By determining the size of the tracking target group in this manner, it is possible to control a PTZ operation performed by the driving unit 109 of the image capture apparatus 100 with reference to the size in a direction in which the tracking target group spreads more, out of the horizontal direction and the vertical direction in the captured image 401.

Note that the calculation unit 116 may determine, as the size of the tracking target group, the ratio of a diagonal line 409 in the rectangular region 412 to the diagonal line of an outer frame in the captured image 401. Alternatively, the calculation unit 116 may determine the width, the height, or the length of the diagonal line 409 in the rectangular region 412 as the size of the tracking target group.

The calculation unit 116 stores information indicating a calculation result in the storage unit 112.

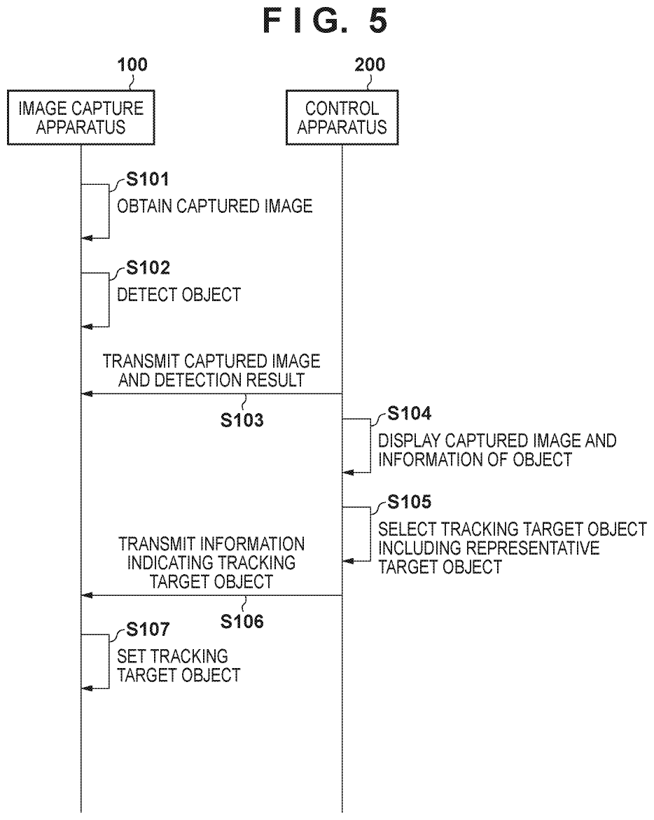

FIG. 5 is a sequence chart showing an operation from when the image capture apparatus 100 transmits a captured image to the control apparatus 200 until the image capture apparatus 100 sets a tracking target object.

In step S101, the obtaining unit 111 of the image capture apparatus 100 obtains a captured image. The captured image obtained by the obtaining unit 111 is stored in the storage unit 112.

In step S102, the detection unit 113 of the image capture apparatus 100 detects an object from the captured image obtained by the obtaining unit 111, and also detects the region of the object in the captured image. In addition, the detection unit 113 identifies the object by detecting the feature of the detected object, and generates information for identifying the object. The detection unit 113 stores, in the storage unit 112, information indicating a detection result including the information for identifying the object.

In step S103, the output unit 114 of the image capture apparatus 100 transmits, to the control apparatus 200, the captured image obtained by the obtaining unit 111 and the information indicating the detection result of the detection unit 113.

In step S104, the output unit 214 of the control apparatus 200 displays, on the display unit 206, the captured image transmitted from the image capture apparatus 100 and the information for identifying the object. More specifically, the output unit 214 displays, on the display unit 206, the captured image on which the information for identifying the object is superimposed.

In step S105, the target setting unit 213 accepts an instruction to select a tracking target object from a plurality of objects in accordance with a user operation on the captured image displayed on the display unit 206.

In step S106, the target setting unit 213 transmits information indicating the tracking target object selected by the user to the image capture apparatus 100 via the output unit 214.

In step S107, the extraction unit 115 of the image capture apparatus 100 sets a tracking target object and a representative target object in accordance with the information transmitted from the control apparatus 200 in step S106. The extraction unit 115 serves as a setting unit capable of setting a plurality of tracking target objects including a representative target object as a tracking target in the captured image. The extraction unit 115 stores information indicating the plurality of tracking target objects including the representative target object in the storage unit 112.

Note that the operation shown in FIG. 5 may be performed for each frame for which the image capture apparatus 100 generates a captured image. Then, every time the user selects a tracking target object, the tracking target object setting may be updated in the image capture apparatus 100 and the control apparatus 200.

This embodiment has explained an example in which the object selected by the user is set as the tracking target object, but the tracking target object setting is not limited to the above-described example. For example, the target setting unit 213 may set, as a tracking target object, a predetermined type of object detected from the captured image. The predetermined type includes, for example, a person. After the user selects a tracking target object, the target setting unit 213 may set, as a tracking target object, an object located near the one tracking target object selected by the user in the captured image. In addition, the target setting unit 213 may set, as a tracking target object, an object having a feature similar to the tracking target object selected by the user in the captured image. Thus, as compared to a case where the user is to select all tracking target objects to be set, the burden of a user operation of setting tracking target objects is reduced.

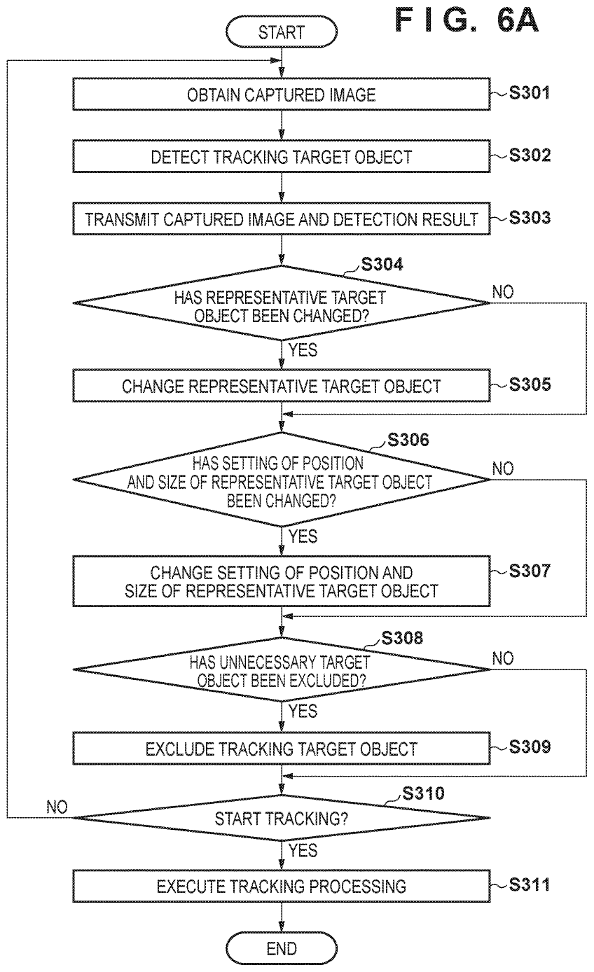

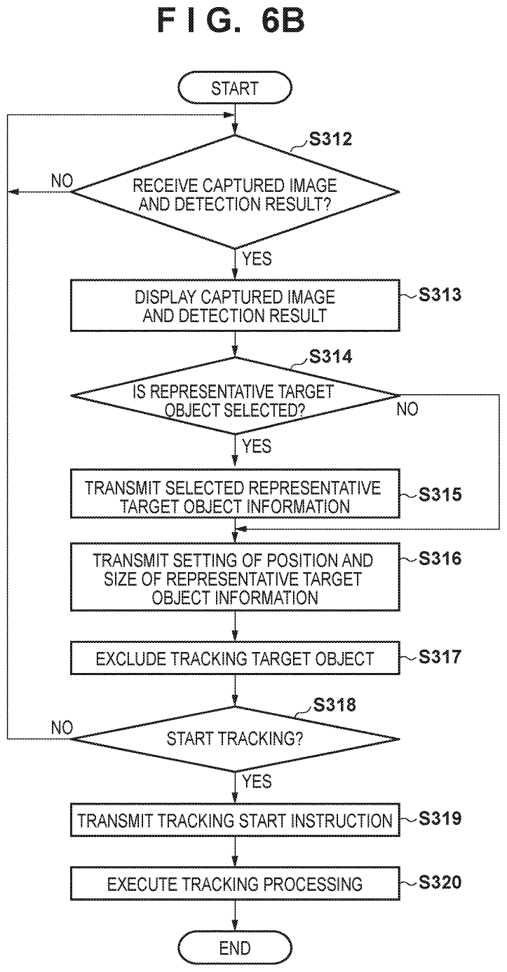

FIGS. 6A and 6B are flowcharts exemplifying the control processing of the image capture apparatus 100 and the control apparatus 200 up to execution of tracking processing according to the first embodiment.

FIG. 6A is a flowchart exemplifying the control processing of the image capture apparatus 100. FIG. 6B is a flowchart exemplifying the control processing of the control apparatus 200.

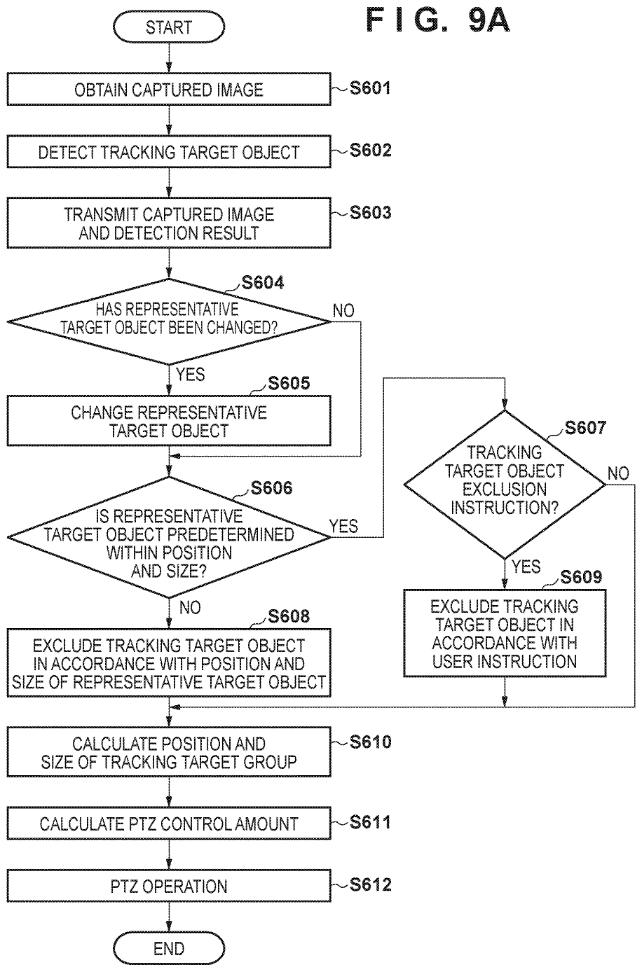

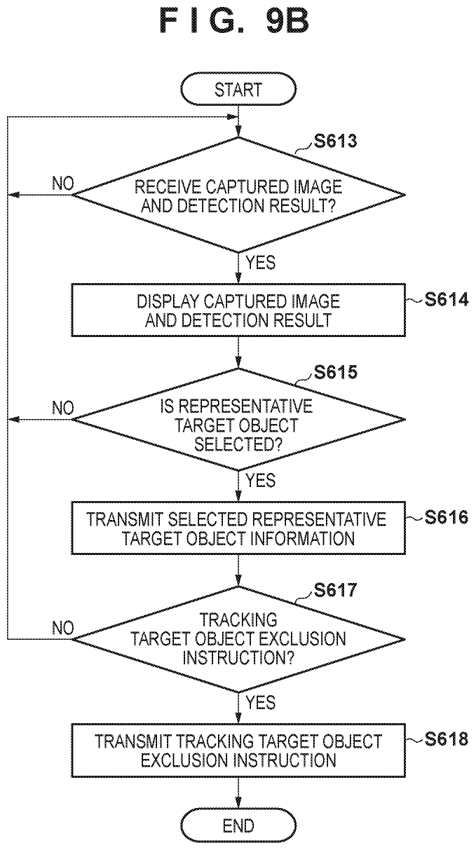

The processing shown in FIG. 6A is implemented when the CPU 101 of the image capture apparatus 100 controls the respective components of the image capture apparatus 100 to operate as the functional units 111 to 117 shown in FIG. 3A by loading the programs stored in the ROM 103 into the RAM 102 and executing them. The processing shown in FIG. 6B is implemented when the CPU 201 of the control apparatus 200 controls the respective components of the control apparatus 200 to operate as the functional units 211 to 214 shown in FIG. 3B by loading the programs stored in the ROM 203 into the RAM 202 and executing them. The same applies to FIGS. 9A and 9B, FIGS. 11A and 11B, and FIGS. 13A and 13B which will be described later.

The processing shown in each of FIGS. 6A and 6B is started when the image capture apparatus 100 generates a captured image in a case where the image capture apparatus 100 is set in a tracking mode, that is, a plurality of tracking target objects including a representative target object are set.

The control processing of the image capture apparatus 100 will be described first with reference to FIG. 6A.

In step S301, the obtaining unit 111 of the image capture apparatus 100 obtains the captured image.

In step S302, the detection unit 113 of the image capture apparatus 100 detects, from the captured image obtained by the obtaining unit 111, an object of the same type as that of the tracking target object set by the extraction unit 115 of the image capture apparatus 100. If the tracking target object set by the extraction unit 115 is a person, the detection unit 113 detects, from the captured image, a person as an object that is a candidate for the tracking target object. In this case, the detection unit 113 identifies the object by detecting the region of the object and detecting the feature of the object, and generates information for identifying the object.

Note that the processes in steps S301 and S302 may be the same as those in steps S101 and S102 of FIG. 5. If the processes in steps S301 and S302 and the processes in steps S101 and S102 are the same processes on the same captured image, the processes in steps S301 and S302 may be omitted.

In step S303, the output unit 114 of the image capture apparatus 100 transmits the captured image obtained by the obtaining unit 111 and information indicating the detection result of the detection unit 113 to the control apparatus 200.

In step S304, based on information received from the control apparatus 200, the extraction unit 115 determines whether the representative target object has been changed. The extraction unit 115 determines whether the representative target object has been changed by extracting the tracking target objects from the captured image and determining whether the representative target object selected from the extracted tracking target objects is different from the tracking target object set in the previous processing. When it is determined that the representative target object has been changed (YES in step S304), the extraction unit 115 advances the process to step S305. When it is determined that the representative target object has not been changed (NO in step S304), the extraction unit 115 advances the process to step S306.

In step S305, the extraction unit 115 changes the representative target object based on the information received from the control apparatus 200, and advances the process to step S306. In step S306, the representative target object set in the previous processing is taken over.

In step S306, based on the information received from the control apparatus 200, the extraction unit 115 determines whether the setting of the position and/or size of the representative target object has been changed. The extraction unit 115 determines whether the setting of the position and/or size of the representative target object has been changed, by reading out the setting of the position and/or size of the representative target object from the storage unit 112 and determining whether the readout position and/or size is different from the position and/or size set in the previous processing. When it is determined that the setting of the position and/or size of the representative target object has been changed (YES in step S306), the extraction unit 115 advances the process to step S307. When it is determined that the setting of the position and/or size of the representative target object has not been changed (NO in step S306), the extraction unit 115 advances the process to step S308.

In step S307, the extraction unit 115 reads out the setting of the position and/or size of the representative target object from the storage unit 112 and changes it based on the information received from the control apparatus 200.

In step S308, the extraction unit 115 takes over the setting of the position and/or size of the representative target object set in the previous processing.

In step S308, the extraction unit 115 determines whether an unnecessary target object exclusion instruction has been received from the control apparatus 200 via the obtaining unit 111. If an unnecessary target object exclusion instruction has been read out from the storage unit 112, the extraction unit 115 determines that the unnecessary target object exclusion instruction has been received from the control apparatus 200. When it is determined that the unnecessary target object exclusion instruction has been received (YES in step S308), the extraction unit 115 advances the process to step S309. When it is determined that no unnecessary target object exclusion instruction has been received (NO in step S308), the extraction unit 115 advances the process to step S310.

In step S309, the extraction unit 115 executes processing of excluding an unnecessary target object based on the unnecessary target object exclusion instruction received from the control apparatus 200.

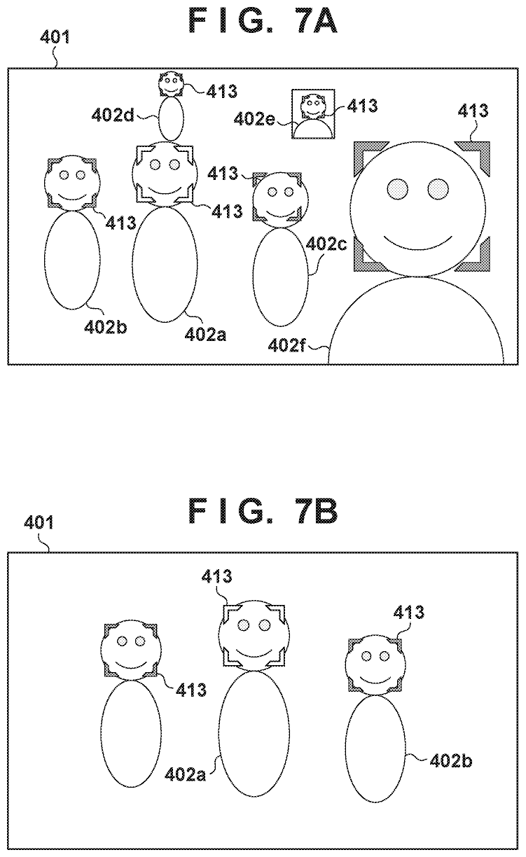

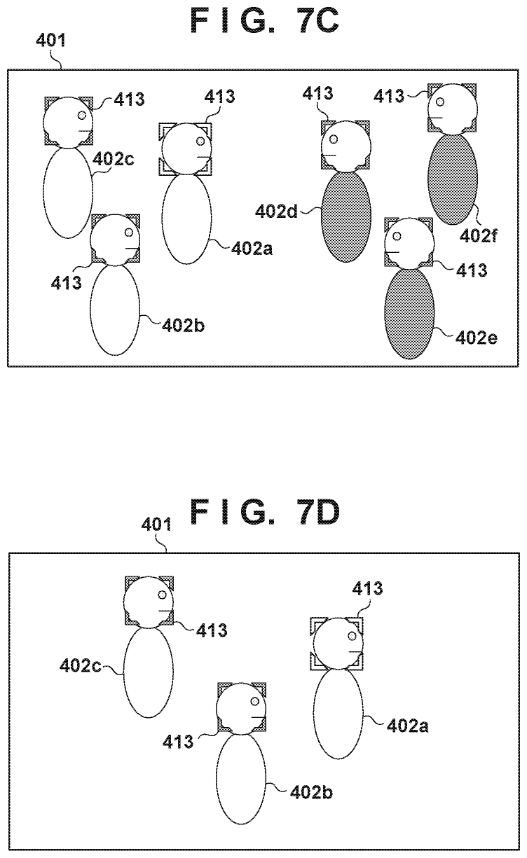

FIGS. 7A to 7D are views illustrating the unnecessary target object exclusion processing in step S309 of FIG. 6A.

FIG. 7A exemplifies the tracking target objects 402b and 402c with positions and/or sizes close to the position and/or size of the representative target object 402a, a distant small object 402d, a small object 402e of a poster which is not an actual object, and a large object 402f.

Since it may become impossible to track the representative target object in a predetermined position and/or size by executing tracking in a state in which the objects 402d to 402f are set as tracking target objects, it is effective to exclude an unnecessary target object before executing the tracking processing.

The extraction unit 115 reads out, from the storage unit 112, a threshold stored in advance, compares the size of the representative target object with that of each tracking target object, extracts the tracking target object for which the difference is equal to or smaller than the threshold, and excludes it from the tracking target objects.

Note that the threshold includes, for example, a value obtained by adding/subtracting a numerical value indicating a predetermined size or length to/from a value indicating the size or length of the representative target object. That is, a value obtained by adding a predetermined value to the size or length of the representative target object can be set as the upper limit of the threshold indicating the size and a value obtained by subtracting the predetermined value from the size or length of the representative target object can be set as the lower limit of the threshold. Any index that allows comparison of the size of the representative target object with that of each tracking target object to determine whether the difference falls within the threshold range may be used. Thus, it is possible to execute appropriate tracking by targeting only the tracking target objects 402a to 402c, as shown in FIG. 7B.

Alternatively, the exclusion processing may be performed in accordance with the distance from the tracking target object instead of the size of the tracking object. In this case, the extraction unit 115 reads out, from the storage unit 112, a threshold stored in advance, compares the coordinates of the representative target object with those of each tracking target object, extracts the tracking target object for which the difference is equal to or larger than the threshold, and excludes it from the tracking target objects. Note that the threshold includes, for example, a value obtained by adding/subtracting predetermined values to/from values indicating the coordinates of the representative target object on the image. That is, values obtained by adding predetermined values of the width and height to the coordinates of the representative target object on the image can be set as the upper limit of the threshold and values obtained by subtracting the predetermined values from the coordinates of the representative target object can be set as the lower limit of the threshold. Any index that allows calculation of the coordinate difference between the representative target object and each tracking target object to determine whether the difference falls within the range may be used. Thus, it is possible to execute appropriate tracking by targeting only the tracking target objects 402a to 402c, as shown in FIG. 7B.

It is also effective to exclude an object with a color and a direction different from those of the representative target object 402a. For example, FIG. 7C exemplifies the tracking target objects 402b and 402c wearing the same clothes and facing in the same direction as the representative target object 402a, and the objects 402d to 402f wearing different clothes and facing in a different direction. In this case, the objects 402d to 402f belong to a group different from the representative target object 402a, and are highly likely to be objects unnecessary for tracking. The detection unit 113 can output color information and the direction information of the object, and the extraction unit 115 can exclude an unnecessary target object by comparing the representative target object with each tracking target object based on the color information and the direction information. Thus, it is possible to execute appropriate tracking by targeting only the tracking target objects 402a to 402c, as shown in FIG. 7D.

Referring back to FIG. 6A, in step S310, the control unit 117 determines whether a tracking start instruction has been received from the control apparatus 200 via the obtaining unit 111. If a tracking start instruction has been read out from the storage unit 112, the control unit 117 determines that the tracking start instruction has been received from the control apparatus 200. When it is determined that the tracking start instruction has been received from the control apparatus 200 (YES in step S310), the control unit 117 advances the process to step S311. When it is determined that no tracking start instruction has been received (NO in step S310), the control unit 117 returns the process to step S301.

In step S311, the control unit 117 executes tracking processing. Details of the tracking processing will be described later.

The control processing of the control apparatus 200 will be described next with reference to FIG. 6B.

In step S312, the obtaining unit 211 of the control apparatus 200 determines whether the captured image and the detection result of the tracking target object included in the captured image have been received from the image capture apparatus 100. The obtaining unit 211 determines whether the captured image or the captured image and the detection result of the tracking target object have been received from the image capture apparatus 100.

The obtaining unit 211 continues the processing until it is determined that the captured image or the captured image and the detection result of the tracking target object have been received from the image capture apparatus 100 (NO in step S312). When it is determined that the captured image or the captured image and the detection result of the tracking target object have been received (YES in step S312), the obtaining unit 211 advances the process to step S313.

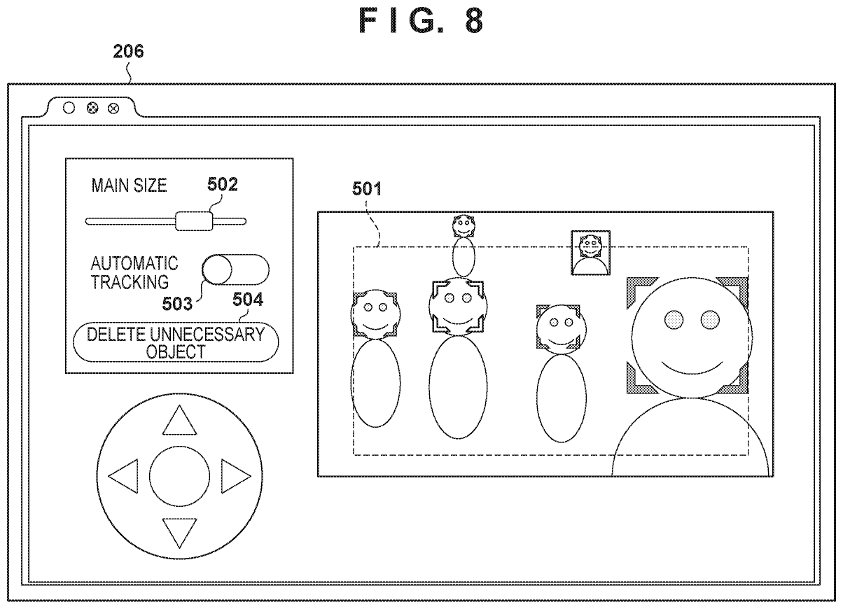

In step S313, the output unit 214 displays, on the display unit 206, the captured image received from the image capture apparatus 100 and information for identifying the object. The output unit 214 displays, on the display unit 206, a GUI exemplified in FIG. 8 for the user to perform each of an operation of setting the position and/or size of the representative target object, an operation of setting an unnecessary target object, and an operation of starting tracking, all of which will be described later.

In step S314, the target setting unit 213 determines whether a user operation of selecting a representative target object from the plurality of tracking target objects included in the captured image displayed on the display unit 206 has been accepted. When it is determined that the user operation of selecting the representative target object has been accepted (YES in step S314), the target setting unit 213 advances the process to step S315. When it is determined that no user operation of selecting the representative target object has been accepted (NO in step S314), the target setting unit 213 advances the process to step S316.

In step S315, the target setting unit 213 transmits information indicating the representative target object selected by the user to the image capture apparatus 100 via the output unit 214.

In step S316, the target setting unit 213 transmits, to the image capture apparatus 100 via the output unit 214, the setting of the position and/or size of the representative target object changed by a user operation on the GUI displayed on the display unit 206. When the user operates a representative target object position rectangle 501 on the GUI shown in FIG. 8 to change a rectangular region, it is possible to execute tracking at such an angle of view that the representative target object falls within the arbitrary representative target object position rectangle 501. In addition, when the user operates a representative target object size setting 502 to change a numerical parameter indicating the size, it is possible to execute tracking at such an angle of view that the representative target object falls within the arbitrary representative target object size setting 502. Note that in the example shown in FIG. 8, the position of the representative target object is set by the rectangular region and the size is set by the numerical parameter. However, the disclosure is not limited to this. For example, setting may be performed by parameters indicating the coordinates of the captured image without operating the rectangle, or may be performed by displaying an icon representing a silhouette of a face, a human body, or the like and operating the size and position of the silhouette. In this case as well, the user can similarly set an arbitrary position and/or size of the representative target object.

In step S317, the target setting unit 213 accepts an unnecessary target object exclusion instruction by a user operation on the GUI displayed on the display unit 206, and transmits the unnecessary target object exclusion instruction to the image capture apparatus 100 via the output unit 214. The user can execute processing of excluding an unnecessary target object by operating an unnecessary object delete button 504 on the GUI shown in FIG. 8.

In step S318, the target setting unit 213 determines whether a tracking start instruction has been accepted by a user operation on the GUI displayed on the display unit 206. The user can instruct to start or stop tracking by operating a tracking execution button 503 on the GUI shown in FIG. 8. When it is determined that the tracking start instruction has been accepted (YES in step S318), the target setting unit 213 advances the process to step S319. When it is determined that no tracking start instruction has been accepted (NO in step S318), the target setting unit 213 returns the process to step S312.

In step S319, the target setting unit 213 transmits the tracking start instruction to the image capture apparatus 100 via the output unit 214.

In step S320, the control apparatus 200 executes processing after the start of the tracking processing in the image capture apparatus 100. Details of this processing will be described later.

The control processing after the start of the tracking processing in step S311 of FIG. 6A and step S320 of FIG. 6B will be described next with reference to FIGS. 9A and 9B.

FIG. 9A exemplifies the control processing of the image capture apparatus 100, and the processing in step S311 of FIG. 6A. FIG. 9B exemplifies the control processing of the control apparatus 200, and the processing in step S320 of FIG. 6B.

Steps S601 to S605 of FIG. 9A are the same as steps S301 to S305 of FIG. 6A.

In step S606, the extraction unit 115 determines whether the position and/or size of the representative target object falls within the predetermined position and/or size stored in the storage unit 112. When it is determined that the position and/or size of the representative target object falls within the predetermined position and/or size (YES in step S606), the extraction unit 115 advances the process to step S607. When it is determined that the position and/or size of the representative target object falls outside the predetermined position and/or size (NO in step S606), the extraction unit 115 advances the process to step S608.

In step S608, the extraction unit 115 executes processing of extracting an unnecessary target object from the tracking target objects and excluding it from the tracking target objects.

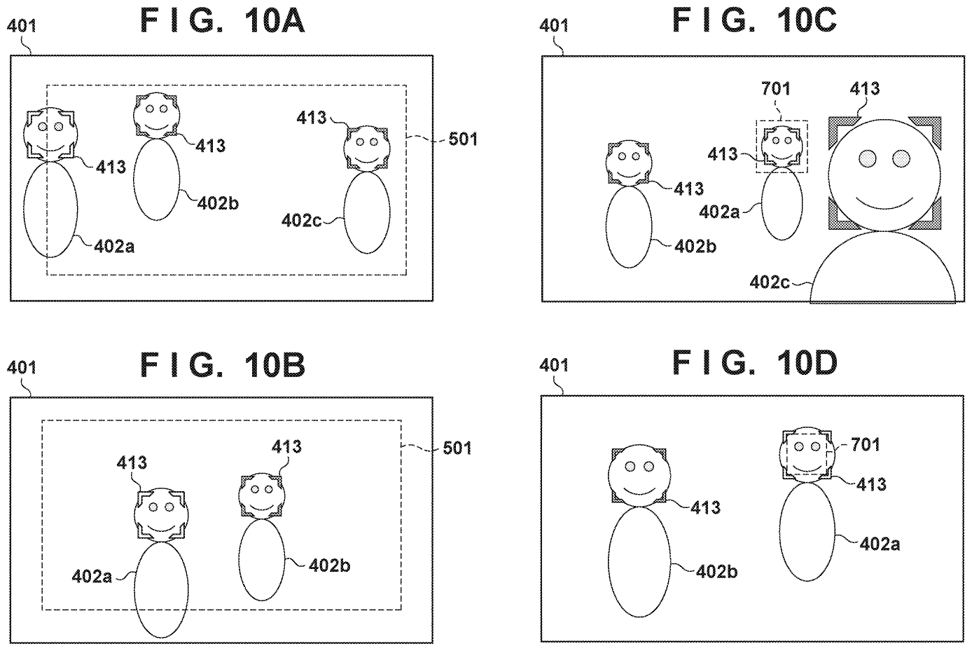

FIGS. 10A to 10D are views illustrating the processing of extracting an unnecessary target object from the tracking target objects and excluding it from the tracking target objects.

FIG. 10A exemplifies a state in which the rectangular image 413 of the representative target object 402a does not fall within the representative target object position rectangle 501. The representative target object position rectangle 501 is set by the user operation in step S316 of FIG. 6B. By reading out the predetermined position and/or size stored in the storage unit 112 via the obtaining unit 111, the target setting unit 213 can determine whether the position and/or size of the representative target object falls within the predetermined position and/or size.

As shown in FIG. 10A, since in the state in which the representative target object 402a does not fall within the representative target object position rectangle 501, a tracking state unintended by the user is set, in one embodiment, the angle of view is modified so that the representative target object 402a falls within the representative target object position rectangle 501. If the position of the representative target object falls outside the representative target object position rectangle, it may be impossible to appropriately control the angle of view due to an object on the opposite side of the position of the representative target object. In the example shown in FIG. 10A, since the tracking target object 402c is a tracking target object, it may be impossible to appropriately control the angle of view. Therefore, it is possible to modify the angle of view so that the representative target object 402a falls within the representative target object position rectangle 501 by excluding, from the tracking target objects, the object 402c farthest from the representative target object 402a. Thus, as shown in FIG. 10B, it is possible to execute tracking at such an angle of view that the representative target object 402a falls within the predetermined position while keeping the plurality of tracking target objects within the angle of view.

Referring to FIG. 10C, a target size rectangle 701 indicating the set size of the representative target object does not fall within the rectangular image 413 of the representative target object 402a, that is, the size of the representative target object 402a is smaller than the set size, and thus tracking unintended by the user is executed. If the size of the representative target object falls outside the target size rectangle 701, it may be impossible to appropriately control the angle of view due to an object having a large difference in size from the representative target object. In the example shown in FIG. 10C, since the tracking target object 402c is a tracking target object, it may be impossible to appropriately control the angle of view. Therefore, it is possible to modify the angle of view so that the rectangular image 413 of the representative target object 402a falls within the target size rectangle 701 by excluding, from the tracking target objects, the object 402c having the largest difference in size from the representative target object 402a. Thus, as shown in FIG. 10D, it is possible to execute tracking at such an angle of view that the representative target object 402a falls within the predetermined size while keeping the plurality of tracking target objects within the angle of view.

Note that this embodiment has explained the position and size of the representative target object separately for the sake of easy understanding, but the disclosure is not limited to this. For example, to modify the angle of view so that the representative target object 402a falls within the representative target object position rectangle 501, it may be possible to achieve such an angle of view that the representative target object falls within the predetermined position and/or size by excluding an object having the largest difference in size from the representative target object 402a. To modify the angle of view so that the rectangular image 413 of the representative target object 402a falls within the target size rectangle 701, it may be possible to achieve such an angle of view that the representative target object falls within the predetermined position and/or size by excluding a farthest object. It is also possible to derive an unnecessary target object by using the above methods in combination.

Referring back to FIG. 9A, in step S607, the extraction unit 115 determines whether an unnecessary target object exclusion instruction has been received from the control apparatus 200 via the obtaining unit 111. If an unnecessary target object exclusion instruction has been read out from the storage unit 112, the extraction unit 115 determines that the unnecessary target object exclusion instruction has been received from the control apparatus 200. When it is determined that the unnecessary target object exclusion instruction has been received from the control apparatus 200 (YES in step S607), the extraction unit 115 advances the process to step S609. When it is determined that no unnecessary target object exclusion instruction has been received (NO in step S607), the extraction unit 115 advances the process to step S610.

In step S609, the extraction unit 115 executes processing of excluding an unnecessary target object based on the unnecessary target object exclusion instruction received from the control apparatus 200. The extraction unit 115 executes the same processing as in step S309 of FIG. 6A, thereby extracting an unnecessary target object and excluding it from the tracking target objects.

In step S610, the calculation unit 116 calculates the reference position and/or size of the tracking target group.

In step S611, the control unit 117 compares the reference position calculated for the tracking target group by the calculation unit 116 with the position set by the user as the target position of the tracking target group in the captured image, and calculates the control amount of pan and tilt in accordance with a comparison result. In this case, the control unit 117 determines the direction and speed of pan and tilt so that the reference position calculated for the tracking target group becomes close to the target position. The control unit 117 determines the speed of pan and tilt so that the speed of pan and tilt is higher as the difference between the target position and the reference position calculated for the tracking target group is larger. In this case, pan and tilt are controlled so that the reference position calculated for the tracking target group becomes close to the target position.

The control unit 117 calculates the difference between the size calculated for the tracking target group by the calculation unit 116 and the value set by the user as the target value of the size of the tracking target group in the captured image, and calculates the control amount of zoom in accordance with the calculated difference. In this case, the control unit 117 determines whether to cause the driving unit 109 to zoom in or out so that the calculated difference becomes small. Furthermore, the control unit 117 determines the speed of zoom so that the speed of zoom is higher as the calculated difference is larger. In this case, zoom is controlled so that the size calculated for the tracking target group becomes close to the target value.

Note that the control unit 117 may set a different speed of zoom even when the calculated difference is the same between a case where the driving unit 109 is caused to zoom in and a case where the driving unit 109 is caused to zoom out. The control unit 117 may set a higher speed of zoom in a case where the driving unit 109 is caused to zoom out, as compared to a case where the driving unit 109 is caused to zoom in. In this case, responsiveness of tracking of the image capture apparatus 100 to the spread of the tracking target group is improved.

In step S612, the control unit 117 causes the driving unit 109 to perform a PTZ operation by the PTZ control amounts determined in step S611. More specifically, the control unit 117 gives, to the driving unit 109, an operation instruction indicating the contents determined in step S611. Thus, the driving unit 109 performs a PTZ operation in accordance with the instruction from the control unit 117.

Note that if no tracking target object is extracted in this tracking processing, the control unit 117 does not control the driving unit 109. If only one tracking target object is extracted in this tracking processing, the control unit 117 causes the driving unit 109 to perform a PTZ operation so as to track the extracted one tracking target object.

Note that the tracking processing may end when an end condition is satisfied after performing the processing in step S612. The end condition includes, for example, acceptance of a tracking processing end instruction from the image capture apparatus 100 or the control apparatus 200, the reaching of a predetermined date/time, and the lapse of a predetermined time from the start of the tracking processing. If the end condition is not satisfied, the processing from step S601 may be repeated by targeting a newly generated captured image.

Steps S613 to S616 of FIG. 9B are the same as steps S312 to S315 of FIG. 6B.

In step S617, the target setting unit 213 of the control apparatus 200 determines whether an unnecessary target object exclusion instruction has been accepted by a user operation on the GUI displayed on the display unit 206. When it is determined that the unnecessary target object exclusion instruction has been accepted (YES in step S617), the target setting unit 213 advances the process to step S618, and transmits the unnecessary target object exclusion instruction to the image capture apparatus 100 via the output unit 214. When it is determined that no unnecessary target object exclusion instruction has been accepted (NO in step S617), the target setting unit 213 returns the process to step S613.

As described above, according to the first embodiment, by extracting an unnecessary target object and excluding it from the tracking target objects based on the position and/or size of the representative target object, it is possible to execute tracking at such an angle of view that the representative target object falls within the predetermined position and/or size while keeping the plurality of tracking target objects within the angle of view.

Note that after excluding the unnecessary target object according to this embodiment, the object can be set again as the tracking target object. In this case, the extraction unit 115 stores information concerning the unnecessary target and exclusion time information in the storage unit 112 in step S309 of FIG. 6A or step S608 or S609 of FIG. 9A. Then, when a predetermined time elapses from the time information stored in the storage unit 112, the information of the excluded tracking target object and the time information are discarded, and thus the object can be set again as the tracking target object. The predetermined time is stored in the storage unit 112, and may be programmed in advance or may be set by user using the control apparatus 200 and stored in the storage unit 112. By providing an exclusion period, it is possible to suppress occurrence of fluctuations of the angle of view caused by repeatedly excluding and adding the object from and to the tracking target objects, and to cope with a case where the user wants to add again the object to the tracking target objects.

In the control processing shown in FIGS. 9A and 9B, processing of changing the position and/or size of the representative target object may be performed. In this case, the target setting unit 213 of the control apparatus 200 accepts a user operation of changing the position and/or size of the representative target object after the processing in step S616, and transmits, to the image capture apparatus 100 via the output unit 214, an instruction to change the position and/or size of the representative target object. If the instruction to change the position and/or size of the representative target object has been received, the extraction unit 115 of the image capture apparatus 100 changes the position and/or size of the representative target object, similar to step S307, after the processing in step S605. This makes it possible to set an angle of view intended by the user by changing the position and/or size of the representative target object even during execution of tracking.

### Second Embodiment

The second embodiment will be described next.

A system configuration and the hardware configurations and functional configurations of an image capture apparatus 100 and a control apparatus 200 according to the second embodiment are the same as in FIGS. 1 to 3 of the first embodiment. Different points from the first embodiment will mainly be described below and the same description as in the first embodiment will be omitted.

In the first embodiment, by excluding an unnecessary target object from tracking target objects, tracking is executed at such an angle of view that a representative target object falls within a predetermined position and/or size while keeping a plurality of tracking target objects within the angle of view. To the contrary, in the second embodiment, by setting the position and/or size of a tracking target group that places importance on a representative target object, tracking is executed at such an angle of view that the representative target object falls within a predetermined position and/or size while keeping a plurality of tracking target objects within the angle of view.

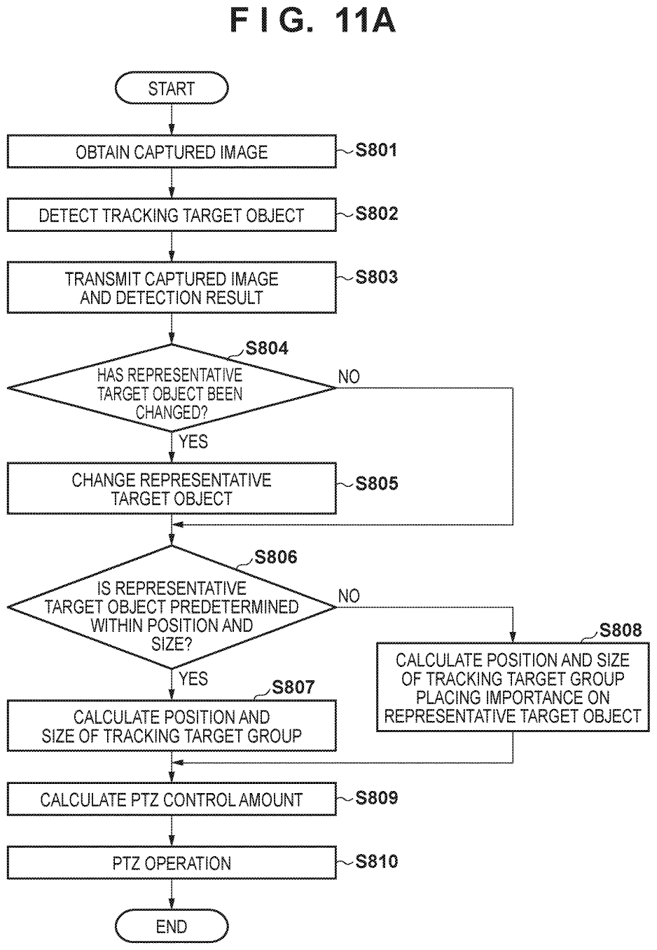

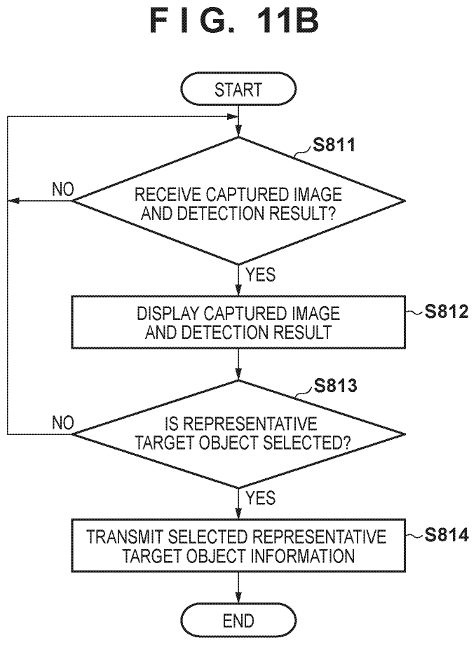

FIG. 11A is a flowchart exemplifying the control processing of the image capture apparatus 100. FIG. 11B is a flowchart exemplifying the control processing of the control apparatus 200.

Steps S801 to S806 are the same as steps S601 to S606 of FIG. 6A.

When it is determined in step S806 that the position and/or size of a representative target object falls within a predetermined position and/or size (YES in step S806), an extraction unit 115 advances the process to step S807, and a calculation unit 116 calculates the reference position and/or size of a tracking target group.

When it is determined that the position and/or size of the representative target object falls outside the predetermined position and/or size (NO in step S806), the extraction unit 115 advances the process to step S808, and the calculation unit 116 calculates the reference position and/or size of the tracking target group that places importance on the representative target object.

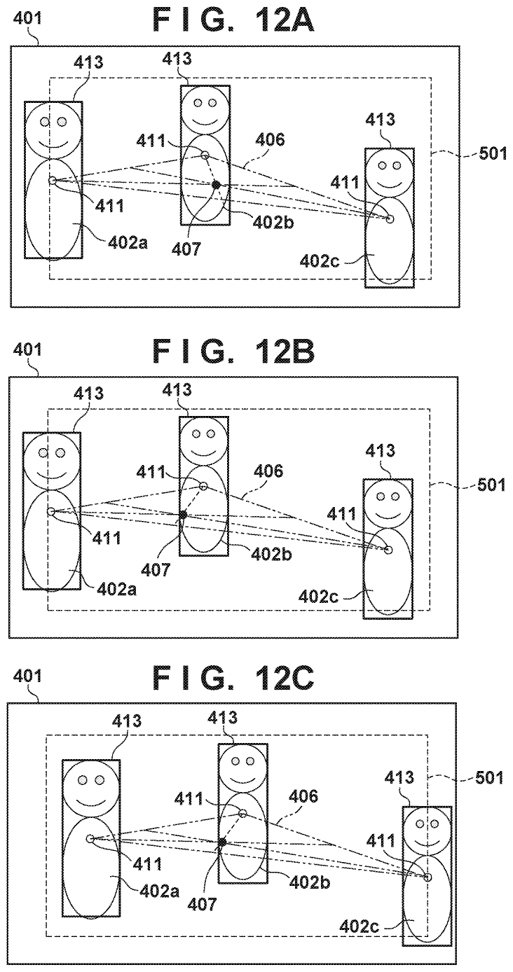

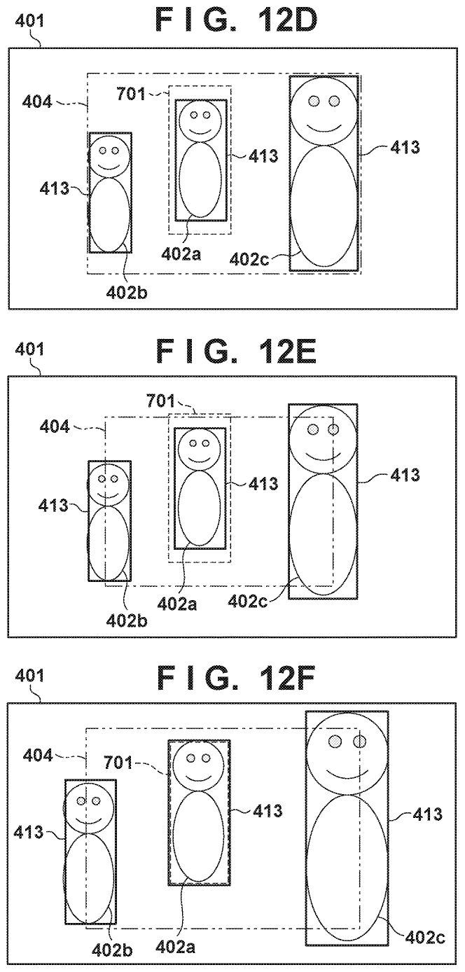

FIGS. 12A to 12F are views illustrating processing in which the calculation unit 116 calculates the reference position and/or size of the tracking target group that places importance on the representative target object.

FIGS. 12A to 12F show a tracking target group of a plurality of tracking target objects 402 including a representative target object 402a, a tracking target object 402b, and a tracking target object 402c, and shows a rectangular image 413 for each tracking target object 402.

FIG. 12A exemplifies a state in which the centroid of a polygon 406 is calculated by giving the same weight to the representative target object 402a and the remaining tracking target objects 402b and 402c but the rectangular image 413 of the representative target object 402a does not fall within a representative target object position rectangle 501. In the example shown in FIG. 12A, it is impossible to calculate the reference position that places importance on the position of the representative target object, and it may be impossible to track the representative target object at the predetermined position.

FIG. 12B exemplifies a state in which the calculation unit 116 calculates the centroid of the polygon 406 by increasing the weight of the representative target object 402a and calculates the calculated centroid as a reference position 407. By executing tracking in this state, it is possible to implement such an angle of view that the rectangular image 413 of the representative target object 402a falls within the representative target object position rectangle 501, as shown in FIG. 12C. This makes it possible to execute tracking at such an angle of view that the representative target object 402a falls within the predetermined position while keeping a plurality of tracking target objects within the angle of view. Note that the weight parameter may be programmed in advance, or may be set by the user using the control apparatus 200 and stored in a storage unit 112. By reading out the weight parameter from the storage unit, the calculation unit 116 can calculate the reference position of the tracking target group that places importance on the position of the representative target object. In the second embodiment, the centroid is calculated by weighting the representative target object in a case where the representative target object 402a does not fall within the predetermined position and/or size. However, the disclosure is not limited to this, and can be implemented by any method of calculating the reference position of the tracking target group that places importance on the representative target object. For example, after calculating a rectangular region 404 and calculating a reference position 405 with reference to FIG. 4A, the coordinate average of the representative target object 402a and the reference position 405 may be calculated and the coordinate position may be set as the reference position 405. This makes it possible to calculate the reference position that places importance on the representative target object. Alternatively, the target position in which the tracking target group falls may be changed so as to obtain the reference position that places importance on the representative target object. This makes it possible to execute tracking that places importance on the representative target object.

FIG. 12D exemplifies a state in which the rectangular region 404 including all of the representative target object 402a and the remaining tracking target objects 402b and 402c is calculated but a target size rectangle 701 does not fall within the rectangular image 413 of the representative target object 402a. In the example shown in FIG. 12D, it is impossible to calculate the size of the tracking target group that places importance on the size of the representative target object, and it may be impossible to track the representative target object with the predetermined size.

FIG. 12E exemplifies a state in which after calculating the rectangular region 404, the calculation unit 116 calculates the ratio between the height of the rectangular image 413 of the representative target object 402a and the height of the rectangular region 404, and newly calculates the rectangular region 404 by multiplying the width and height of the rectangular region 404 by the ratio. This makes it possible to calculate the rectangular region 404 in consideration of the size of the representative target object 402a, and it is possible to implement such an angle of view that the target size rectangle 701 falls within the rectangular image 413 of the representative target object 402a, as shown in FIG. 12F, by executing tracking in this state. Therefore, it is possible to execute tracking at such an angle of view that the representative target object 402a falls within the predetermined position and/or size while keeping the plurality of tracking target objects within the angle of view. Note that in this embodiment, in a case where the representative target object 402a does not fall within the predetermined position and/or size, the rectangular region 404 is recalculated using the height of the rectangular image 413 of the representative target object 402a. However, the disclosure is not limited to this, and can be implemented by any method of executing tracking with a size that places importance on the representative target object. For example, the disclosure may be implemented by calculating a rectangular area 408 or the length of a diagonal line 409 with reference to FIG. 4B or 4D and recalculating the size of the tracking target group from the ratio relative to the representative target object 402a. Instead of the size of the tracking target group, an angle of view at which the tracking target group is captured may be changed by changing the value set by the user as the target value of the size of the tracking target group. Even in a case where the target size of the tracking target group is changed, it is possible to execute tracking at such an angle of view that the representative target object falls within the predetermined position and/or size while tracking the plurality of tracking target objects.

Steps S809 to S814 are the same as steps S611 to S616 of FIGS. 9A and 9B.

As described above, according to the second embodiment, by calculating the position and/or size of the tracking target group that places importance on the representative target object, it is possible to execute tracking at such an angle of view that the representative target object falls within the predetermined position and/or size while keeping the plurality of tracking target objects within the angle of view.

Note that in the second embodiment, the processing of excluding the unnecessary target object in steps S308 and S309 of FIG. 3A or step S317 of FIG. 3B of the first embodiment is not performed. However, processing of excluding an unnecessary target object may be performed. In this case, the process transitions to the processing in steps S308 and S309 after step S805 and to the processing in step S318 after step S814.

### Third Embodiment

The third embodiment will be described next.

A system configuration and the hardware configurations and functional configurations of an image capture apparatus 100 and a control apparatus 200 according to the third embodiment are the same as in FIGS. 1 to 3 of the first embodiment. Different points from the first embodiment will mainly be described below and the same description as in the first embodiment will be omitted.

In the third embodiment, a tracking inhibited region as a region where tracking is not desired by the user is set, and a tracking target object included in the tracking inhibited region is excluded. This makes it possible to execute tracking at such an angle of view that a representative target object falls within a predetermined position and/or size while keeping a plurality of tracking target objects within the angle of view without including an unnecessary tracking target object. In addition, if the representative target object enters the tracking inhibited region, it is possible to suppress unnecessary tracking and to maintain the angle of view desired by the user by stopping tracking.

A target setting unit 213 according to this embodiment accepts an instruction to set a tracking inhibited region in accordance with a user operation on a GUI displayed on a display unit 206, and stores it in a storage unit 212. Note that the number of tracking inhibited region settings is not limited to one and can be plural.

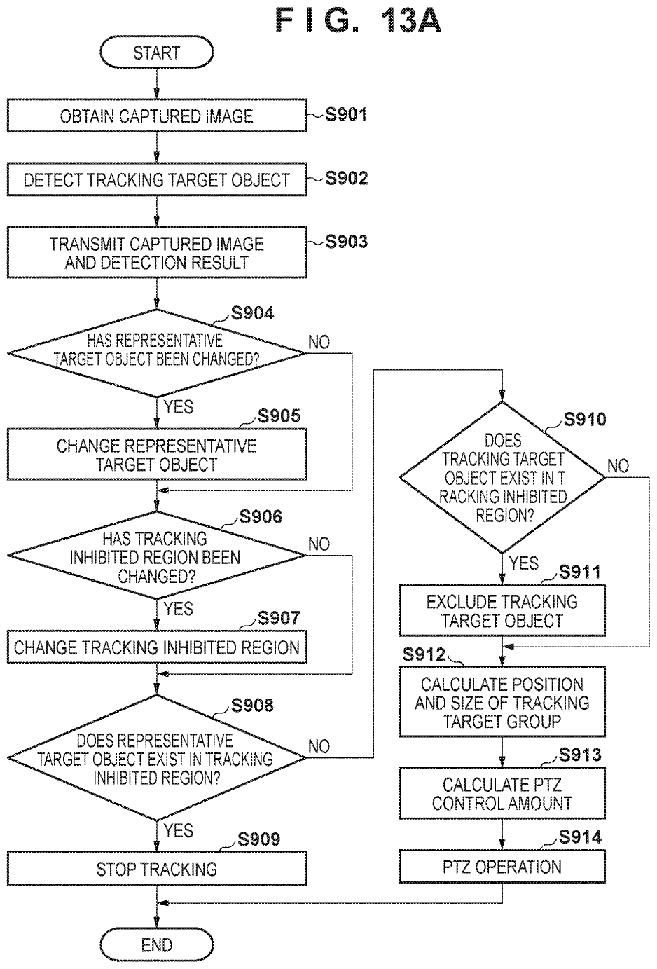

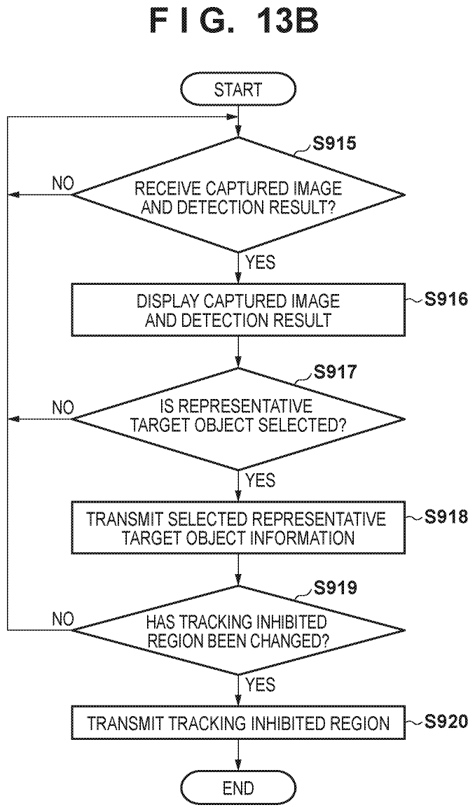

FIG. 13A is a flowchart exemplifying the control processing of the image capture apparatus 100. FIG. 13B is a flowchart exemplifying the control processing of the control apparatus 200.

Steps S901 to S905 are the same as steps S601 to S605 of FIG. 9A.

In step S906, the extraction unit 115 determines, based on information received from the control apparatus 200, whether the tracking inhibited region setting has been changed. The extraction unit 115 reads out the tracking inhibited region setting stored in a storage unit 112, and determines whether the readout tracking inhibited region setting is different from the tracking inhibited region setting received from the control apparatus 200.

When it is determined that the tracking inhibited region setting has been changed (YES in step S906), the extraction unit 115 advances the process to step S907, and changes, based on the information received from the control apparatus 200, the tracking inhibited region setting stored in the storage unit 112. When it is determined that the tracking inhibited region setting has not been changed (NO in step S906), the extraction unit 115 takes over the tracking inhibited region set in the previous processing.

In step S908, the extraction unit 115 determines whether the position of the representative target object falls within the tracking inhibited region stored in the storage unit 112. When it is determined that the position of the representative target object falls within the tracking inhibited region (YES in step S908), the extraction unit 115 advances the process to step S909, and stops the tracking operation. When it is determined that the position of the representative target object falls outside the tracking inhibited region (NO in step S908), the extraction unit 115 advances the process to step S910. Note that if, after stopping the tracking operation in step S909, it is determined again in step S908 that the position of the representative target object falls outside the tracking inhibited region, the extraction unit 115 can advance the process to step S910, and can resume the tracking operation.

In step S910, the extraction unit 115 determines whether there exists a tracking target object falling within the tracking inhibited region stored in the storage unit 112. When it is determined that there exists a tracking target object falling within the tracking inhibited region (YES in step S910), the extraction unit 115 advances the process to step S911, and excludes the tracking target object falling within the tracking inhibited region from the tracking target objects. When it is determined that there exists no tracking target object falling within the tracking inhibited region (NO in step S910), the extraction unit 115 advances the process to step S912.

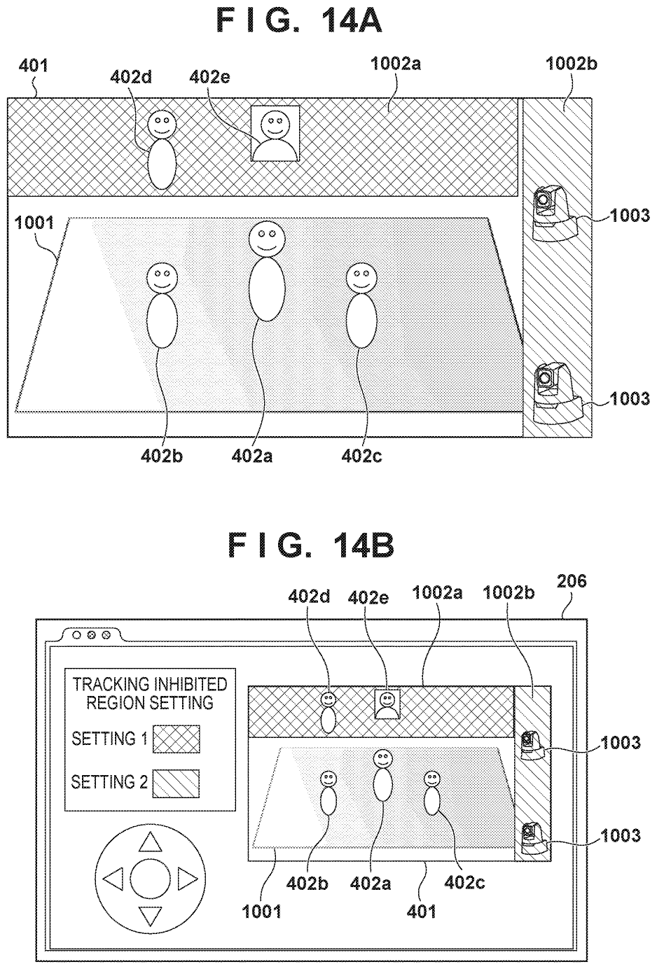

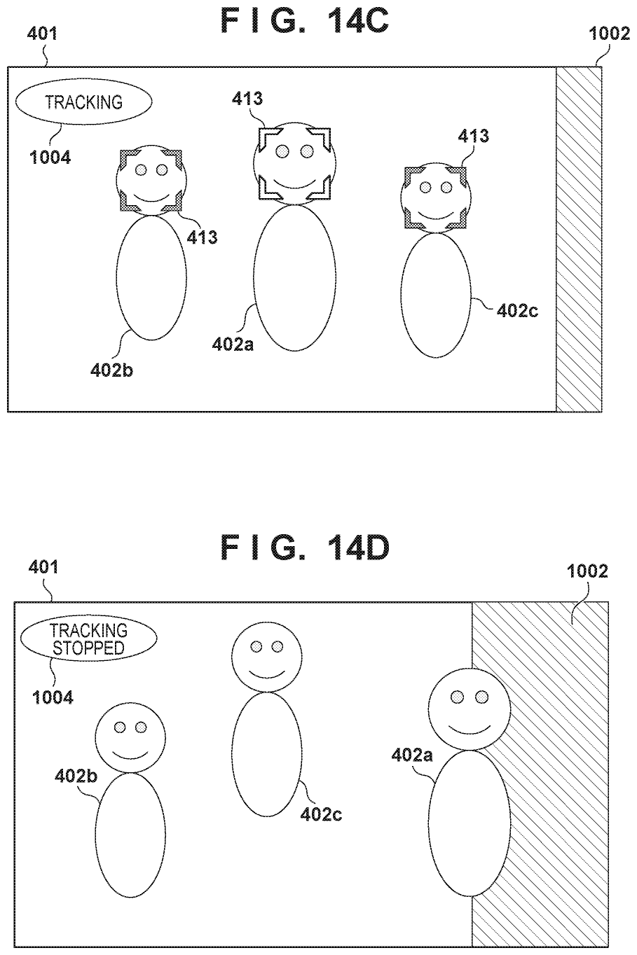

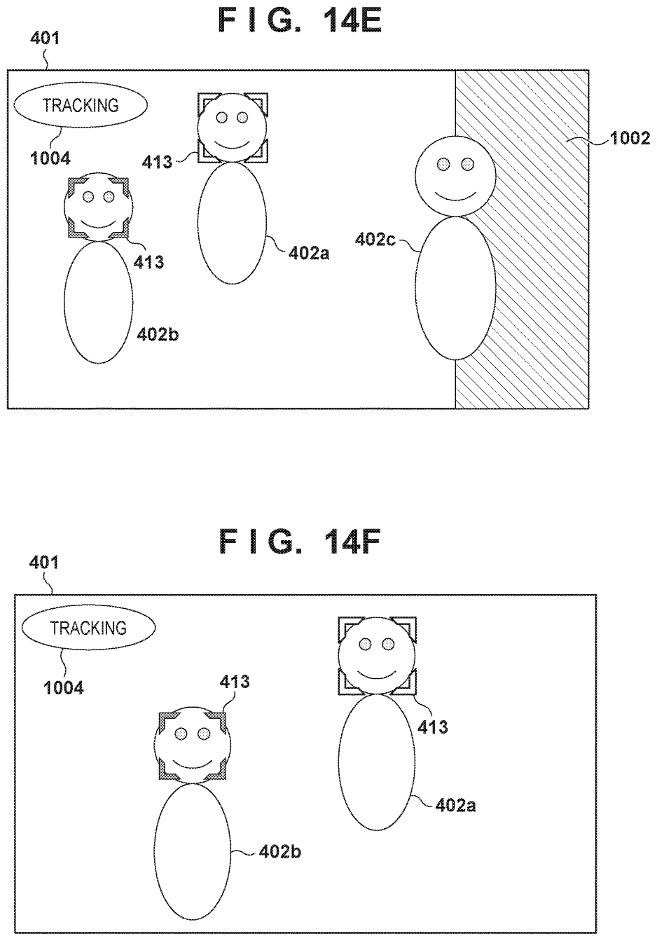

FIGS. 14A to 14F are views illustrating processing in which the extraction unit 115 determines whether the representative target object and the tracking target object fall within a tracking inhibited region.

FIG. 14A exemplifies processing of setting a tracking inhibited region before executing tracking. In the example shown in FIG. 14A, it is intended to perform tracking in a stage 1001 including objects 402a to 402c, and it is not intended to track a region including an object 402d and a small object 402e of a poster which is not an actual object, and a region including an unnecessary object 1003. The user can instruct a tracking inhibited region 1002 by operating the GUI displayed on the display unit 206 of the control apparatus 200, as shown in FIG. 14B, thereby setting the tracking inhibited region 1002 including the objects 402d and 402e and the unnecessary object 1003. The target setting unit 213 of the control apparatus 200 transmits information indicating the set tracking inhibited region to the image capture apparatus 100 via an output unit 214. By reading out the information indicating the tracking inhibited region obtained from the control apparatus 200 via an obtaining unit 111 and stored in the storage unit 112, the extraction unit 115 of the image capture apparatus 100 can determine whether the representative target object and the tracking target object which is not the representative target object fall within the tracking inhibited region. Note that in this embodiment, a region is operated to set a tracking inhibited region, but the disclosure is not limited to this. For example, parameters indicating the coordinates of a captured image may be used to perform setting without operating a region. In this case as well, the user can set an arbitrary tracking inhibited region.

FIGS. 14C to 14F are views illustrating an operation in a case where the representative target object and the tracking target object which is not the representative target object fall within the tracking inhibited region. Each of FIGS. 14C to 14F shows a tracking status 1004 indicating the tracking processing state of the image capture apparatus 100 superimposed on a captured image 401. The tracking processing state includes, for example, “tracking” and “tracking stopped”. Note that this embodiment shows the tracking status 1004 superimposed on the captured image 401 for the sake of easy understanding, but the disclosure is not limited to this.

FIG. 14C exemplifies a state in which the representative target object 402a and the tracking target objects 402b and 402c are tracked. FIG. 14D exemplifies a state in which tracking processing is further executed in the state shown in FIG. 14C and the representative target object 402a falls within the tracking inhibited region 1002. As shown in FIGS. 14C and 14D, when the representative target object 402a enters the tracking inhibited region 1002, the tracking status 1004 transitions from “tracking” to “tracking stopped”. In this way, when it is determined that the representative target object enters the tracking inhibited region, the tracking is stopped. FIG. 14E exemplifies a state in which tracking processing is further executed in the state shown in FIG. 14C and the tracking target object 402c falls within the tracking inhibited region 1002. In this case, as shown in FIGS. 14C and 14E, even if the tracking target object 402c enters the tracking inhibited region 1002, the tracking status 1004 remains unchanged. The rectangular image 413 of the tracking target object 402c disappears to indicate that the tracking target object 402c is excluded from the tracking target objects. By executing tracking in this state, it is possible to execute tracking at such an angle of view that the representative target object falls within the predetermined position and/or size while excluding the tracking target object falling within the tracking inhibited region and falling a plurality of tracking target objects within the angle of view, as shown in FIG. 14F. Note that in this embodiment, when the representative target object enters the tracking inhibited region, the tracking status is set to “tracking stopped”. However, any tracking status indicating that tracking is not in an execution state, such as “currently lost”, may be set.

Steps S912 to S918 are the same as steps S610 to S616 of FIGS. 9A and 9B.

In step S919, the target setting unit 213 of the control apparatus 200 determines whether an instruction to change the tracking inhibited region setting has been accepted in accordance with a user operation on the GUI displayed on the display unit 206. When it is determined that the tracking inhibited region setting change instruction has been accepted (YES in step S919), the target setting unit 213 advances the process to step S920, and transmits the tracking inhibited region setting changed in step S919 to the image capture apparatus 100 via the output unit 214.

When it is determined that no tracking inhibited region setting change instruction has been accepted (NO in step S919), the target setting unit 213 returns the process to step S915.

As described above, according to the third embodiment, a tracking inhibited region as a region where tracking is not desired by the user is set, tracking is stopped when the representative target object enters the tracking inhibited region, and the tracking target object which is not the representative target object is excluded from the tracking target objects when it enters the tracking inhibited region, thereby making it possible to suppress unnecessary tracking and execute tracking so that the representative target object falls within the predetermined position or size while tracking the plurality of tracking target objects.

Note that FIGS. 13A and 13B show an example of performing processing of excluding the tracking target object, similar to steps S308, S309, and S317 of FIGS. 6A and 6B of the first embodiment, but this processing is not essential and may be omitted. That is, the process may transition to step S310 after the processing in step S307 and to step S318 after the processing in step S316. Furthermore, FIGS. 13A and 13B show an example of setting the position and/or size of the representative target object, similar to steps S306, S307, and S316 of FIGS. 6A and 6B of the first embodiment, but this processing is not essential and may be omitted. That is, the process may transition to step S318 after the processing in step S305 and to step S317 after the processing in step S315.

Note that in the processing of FIGS. 6A and 6B of the first embodiment, the processing of changing the tracking inhibited region setting shown in FIGS. 13A and 13B may be performed. In this case, the target setting unit 213 of the control apparatus 200 accepts a user operation of setting a tracking inhibited region after the processing in step S315, and transmits, in a case where the tracking inhibited region setting has been changed, an instruction to change the tracking inhibited region setting to the image capture apparatus 100 via the output unit 214. If the instruction to change the tracking inhibited region setting has been received, the extraction unit 115 of the image capture apparatus 100 changes the tracking inhibited region setting, similar to step S907, after the processing in step S305. This makes it possible to change the tracking inhibited region setting before executing tracking, and execute tracking in a state in which the setting desired by the user is made.

### Modification

A method of determining a tracking target group is not limited to that described in this embodiment, and other methods may be used. For example, specific objects such as persons (faces or heads) and animals may be detected, representative target object determination processing may be performed based on factors such as the position and the size of the object in the angle of view detected as a person (face or head), an animal, or other specific target detected using personal authentication or the like, or based on user selection or the like, the selected representative target object may be set as a tracking target object, and objects falling within a predetermined distance range of the representative target object and detected by the specific object detection processing may be grouped and set as tracking target objects.

This embodiment has explained an example of setting tracking target objects by the control apparatus 200, but the disclosure is not limited to this. For example, the image capture apparatus 100 may set tracking target objects. That is, the image capture apparatus 100 may have the function of the target setting unit 213 of the control apparatus 200.

This embodiment has explained an example in which the image capture apparatus 100 detects objects, extracts tracking target objects, excludes an unnecessary target object, and controls the position and/or size of a tracking target group including a representative target object, but the disclosure is not limited to this. For example, the control apparatus 200 may perform processing of detecting objects, extracting tracking target objects, excluding an unnecessary target object, and controlling the position and/or size of a tracking target group including a representative target object. That is, the control apparatus 200 may have the functions of the detection unit 113, the extraction unit 115, the calculation unit 116, and the control unit 117 of the image capture apparatus 100.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-049083, filed Mar. 24, 2025, which is hereby incorporated by reference herein in its entirety.

What is claimed is:

1. A system which tracks a plurality of objects included in an image, comprising:
at least one processor; and
at least one memory which stores a program which, when executed by the at least one processor, causes the at least one processor to function as:
a detection unit that detects a plurality of objects from the image;
a setting unit that sets a plurality of tracking target objects including a representative target object from the detected plurality of objects; and
a control unit that tracks the plurality of tracking target objects by controlling an angle of view so that the representative target object falls within a predetermined position and/or size.

2. The system according to claim 1, wherein
the setting unit sets a position and/or size of the representative target object and an object to be excluded from the tracking target objects.

3. The system according to claim 2, wherein
the setting unit sets the object to be excluded from the tracking target objects based on a user operation.

4. The system according to claim 2, wherein
the setting unit extracts the object to be excluded from the tracking target objects based on at least one of pieces of information of positions, sizes, directions, and colors of the representative target object and another tracking target object.

5. The system according to claim 1, wherein the at least one processor further functions as:
an extraction unit that extracts, in a case where the representative target object does not fall within the predetermined position and/or size, the object to be excluded from the tracking target objects.

6. The system according to claim 1, wherein the at least one processor further functions as:
an extraction unit that excludes, in a case where the representative target object falls within the predetermined position and/or size, an object set by a user operation from the tracking target objects.

7. The system according to claim 5, wherein
the extraction unit excludes, from the tracking target objects, an object farthest from the representative target object among the plurality of tracking target objects.

8. The system according to claim 5, wherein
the extraction unit excludes, from the tracking target objects, an object having a largest difference in size from the representative target object among the plurality of tracking target objects.

9. The system according to claim 2, wherein
the object excluded from the tracking target objects can be set again as the tracking target object after a predetermined time elapses since the exclusion.

10. The system according to claim 1, wherein
in a case where the representative target object falls within the predetermined position and/or size, the control unit controls the angle of view based on positions and/or sizes of the plurality of tracking target objects.

11. The system according to claim 1, wherein
in a case where the representative target object does not fall within the predetermined position and/or size, the control unit controls the angle of view based on positions and/or sizes of the plurality of tracking target objects or controls the angle of view based on positions and/or sizes in which the plurality of tracking target objects fall.

12. The system according to claim 10, wherein the at least one processor further functions as:
a calculation unit that calculates the positions and/or sizes of the plurality of tracking target objects,
wherein the control unit controls the angle of view based on the positions and/or sizes of the plurality of tracking target objects and target positions and/or sizes of the plurality of tracking target objects in the image.

13. The system according to claim 1, wherein
the control unit controls the angle of view by controlling pan, tilt, and zoom of an image capture apparatus.

14. The system according to claim 1, wherein the object is a person.

15. The system according to claim 1, further comprising:
an image capture apparatus and a control apparatus,
wherein
the control apparatus includes the setting unit,
the image capture apparatus includes an imaging unit that captures the image, the detection unit, and the control unit,
the image capture apparatus outputs, to the control apparatus, an image captured by the imaging unit and information of the detected objects,
the control apparatus obtains, from the image capture apparatus, the image and the information of the objects detected from the image, and
outputs, to the image capture apparatus, information of the representative target object and the set tracking target objects, information of a position and/or size of the representative target object, and information of an object to be excluded from the tracking target objects, and
the image capture apparatus controls the angle of view and executes the tracking based on the pieces of information obtained from the control apparatus.

16. A method executed by a system which tracks a plurality of objects included in an image, comprising:
detecting objects from the image;
setting a plurality of tracking target objects including a representative target object from the plurality of detected objects; and
tracking the plurality of tracking target objects including the representative target object by controlling an angle of view so that the representative target object falls within a predetermined position and/or size.

17. The method according to claim 16, further comprising extracting, in a case where the representative target object does not fall within the predetermined position and/or size, the object to be excluded from the tracking target objects.

18. A non-transitory computer-readable storage medium storing a program for causing a system which tracks a plurality of objects included in an image to execute a method, comprising:
detecting a plurality of objects from the image;
setting a plurality of tracking target objects including a representative target object from the detected plurality of objects; and
tracking the plurality of tracking target objects by controlling an angle of view so that the representative target object falls within a predetermined position and/or size.

19. The non-transitory computer-readable storage medium according to claim 18, further comprising extracting, in a case where the representative target object does not fall within the predetermined position and/or size, the object to be excluded from the tracking target objects.
